(19) United States
(12) Patent Application Publication
(10) Pub. No.: US 2023/0403162 A1
(43) Pub. Date: Dec. 14, 2023

(54) METHOD FOR SECURING THE OPERATION OF AN INDUSTRIAL SYSTEM AND ASSOCIATED DEVICES

(71) Applicant: SAFT, LEVALLOIS PERRET (FR)

(72) Inventor: Stéphane ALAIMO, BORDEAUX (FR)

(73) Assignee: SAFT, LEVALLOIS PERRET (FR)

(21) Appl. No.: 18/033,440

(22) PCT Filed: Oct. 28, 2021
(86) PCT No.: PCT/EP2021/079935

§ 371 Date: Apr. 24, 2023

(30) Foreign Application Priority Data
Oct. 28, 2020 (FR) 20 11022

(51) Int. Cl. H04L 9/32

(52) U.S. Cl. CPC H04L 9/3263

(57) ABSTRACT

The invention relates to a method for securing the operation of an industrial system comprising pieces of equipment, the process comprising a phase of obtaining a digital certificate authorizing an operator to access a piece of equipment in order to carry out an action, a phase of attempting to access a piece of equipment in order to carry out an action on the piece of equipment, the attempt phase comprising, in particular, a step of authorizing access to the piece of equipment in order to carry out an action when a compliance requirement relating to the digital certificate is met or refusing access when the compliance requirement is not met.

### CROSS REFERENCE TO RELATED APPLICATIONS

The present application is a U.S. National Phase application under 35 U.S.C. § 371 of International Patent Application No. PCT/EP2021/079935 filed Oct. 28, 2021, which claims priority of French Patent Application No. 20 11022 filed Oct. 28, 2020. The entire contents of which are hereby incorporated by reference.

### FIELD OF THE INVENTION

The present invention relates to a method for securing the operation of an industrial system. The present invention further relates to an industrial system and an associated securing system.

### BACKGROUND

With the increasing development of electronic controls, energy systems (production or storage) are becoming more and more complex. Such complexity maintains a high level of safety despite the fact that the performance of energy systems is increasing.

As an illustration, power supplies using batteries are apt to deliver an ever higher electrical power and over ever longer periods of time, but such gain in power and energy density comes along, in particular, with an increase of fire or explosion hazard following a thermal runaway. To ensure safe operation, such power supplies are thus controlled by different electronic equipment.

Ensuring such safe operation means that electronic equipment have to be adjusted during maintenance only by persons having advanced expertise. Indeed, improper adjustment of equipment can lead to unsafe operation which can lead to dramatic accidents.

It is thus desirable to be able to ensure that only authorized persons can access the equipment of an energy system.

To this end, document EP 1906586 A1 discloses a protocol for authenticating an industrial system. The protocol is based on the use of a dedicated component of the industrial system which can communicate secure information along a network. The control is then done by an exchange of private keys at the industrial system.

However, such a protocol cannot be used if the industrial system is not connected to a network.

Moreover, the exchange of private keys is often complicated when the person with the expertise is a person from outside the site, using the industrial system. Such problems develop precisely because the expertise required is of an increasingly high level, so that the expertise is often only available from the company which installed the industrial system.

Finally, such a protocol prevents centralized management and hence efficient information reporting in a case involving a plurality of industrial sites including industrial systems. If each power supply of a certain type has e.g. recurring failures during a specific use, it is not possible to identify that the specific use of said type of power supply is problematic.

Thus, from such different problems, there is a high risk that, in certain cases, the industrial system will be incorrectly configured, which is not acceptable because the industrial system then no longer operates under validated conditions. At best, a loss of performance of the industrial system results therefrom, and above all, a poor configuration of the industrial system can lead the industrial system to operate in dangerous conditions which can lead to short circuits or explosions.

There is thus a need for a method for securing the operation of an industrial system, which could be used effectively in all events which could arise in practice when an operation is to be carried out on the industrial system.

### SUMMARY

To this end, the description describes a method for securing the operation of an industrial system including a set of equipment and a unit for controlling access to equipment, the industrial system being part of an industrial site, the industrial site being part of a group of industrial sites, the group of industrial sites comprising a single centralized control system for the access rights, the method for securing including a phase of obtaining a digital certificate authorizing an operator to access at least one piece of equipment of the industrial system in order to carry out a predefined action. The obtaining phase comprises a step of requesting a generation of a digital certificate by the centralized control system for access rights, the digital certificate being a unique and temporary digital certificate and a step in receiving the digital certificate. The method for securing comprises a phase of attempting to access at least one piece of equipment of the industrial system in order to carry out an action on said at least one piece of equipment, the attempt phase comprising a step of requesting access to at least one piece of equipment of the industrial system by entering a plurality of data relating to the action to be carried out on the control unit for access to equipment, at least one of the plurality of data items relating to the digital certificate, a step performed by the control unit for access to equipment checking the compliance of the access request with at least one compliance requirement, at least one compliance requirement being a compliance requirement relating to the digital certificate, and a step of authorizing access to at least one piece of equipment of the industrial system for carrying out the action when the or each compliance requirement is met or refusing access to at least one piece of equipment of the industrial system when a compliance requirement is not met.

According to other particular embodiments, the method for securing has one or a plurality of the following features, taken individually or according to all technically possible combinations:
the industrial system is an energy production system or an energy storage system.
the industrial system is a power supply including a battery and a battery management system and at least one piece of auxiliary equipment.
each piece of auxiliary equipment is chosen from a fire detection and extinguishing system, an air conditioning system and an electrical power measurement system.
the step of requesting the generation of the digital certificate further includes the connection to a web application, the preparation of a request to generate the digital certificate by entering information on the web application, in order to obtain a prepared request, and transmission to the centralized control system for access rights, the prepared request to generate the digital certificate based on the information entered on the web application.
each compliance requirement relating to the digital certificate is chosen from the following list of compliance requirements: a validity interval being defined for the digital certificate, the request for access to at least one piece of equipment of the industrial system is within the validity period of the digital certificate, the data relating to the action to be carried out entered into the control unit for access to equipment is the same as the action indicated in the digital certificate, and the digital certificate is authentic.

The description further relates to an industrial system including a set of equipment and a control unit for access to the equipment, the industrial system being part of an industrial site, the industrial site being part of a group of industrial sites, the group of industrial sites comprising a single centralized control system for access rights, the control unit for access to equipment being apt to receive a plurality of data on the control unit for access to equipment, at least one datum of the plurality of data relating to a digital certificate authorizing access to at least one piece of equipment of the industrial system, the digital certificate having been generated by the centralized control system for access rights, the digital certificate being a unique and temporary digital certificate, all data forming a request for access to at least one piece of equipment of the industrial system. The control unit is apt to check the compliance of the access request with at least one compliance requirement, at least one compliance requirement being a compliance requirement relating to the digital certificate, and apt authorize access to at least one piece of equipment of the industrial system when the or each compliance requirement is met or refusing access to at least one piece of equipment of the industrial system when a compliance requirement is not met.

The description further relates to a system for securing the operation of an industrial system including a set of equipment and a control unit for access to equipment, the industrial system being part of an industrial site, the industrial site being part of a group of industrial sites, the group of industrial sites comprising a single centralized control system for access rights, the system for securing including a terminal for obtaining a digital certificate authorizing access to at least one piece of equipment of the industrial system, the terminal being suitable for requesting the generation of the digital certificate by the centralized control system for access rights, the digital certificate being a single and temporary digital certificate, suitable for receiving the digital certificate. The control unit for access to equipment is suitable for receiving a plurality of data on the control unit for access to equipment, at least one datum of the plurality of data relating to the digital certificate, all data forming a request for access to at least one piece of equipment of the industrial system, suitable for checking the compliance of the request for access with at least one compliance requirement, at least one compliance requirement being a compliance requirement relating to the digital certificate, and suitable for authorizing access to at least one piece of equipment of the industrial system when the or each compliance requirement is met or refusing access to at least one piece of equipment of the industrial system when a compliance requirement is not met.

The description further relates to a computer program product including program instructions stored on a readable information medium implementing steps of a method as described above when the computer program is implemented on a data processing unit.

The description further relates to a readable information medium on which are stored program instructions implementing steps of a method as described above when the computer program is implemented on a data processing unit.

In the present description, the expression “suitable for” means equally well “apt to” or “configured for”.

### BRIEF DESCRIPTION OF THE DRAWINGS

The features and advantages of the invention will appear upon reading the following description, given only as an example, but not limited to, and making reference to the enclosed drawings, wherein:

FIG. 1 is a schematic view of a group of industrial sites, and

FIG. 2 is a flowchart of an example of implementation of a method for securing the operation of an industrial site which is part of a group of sites.

### DETAILED DESCRIPTION

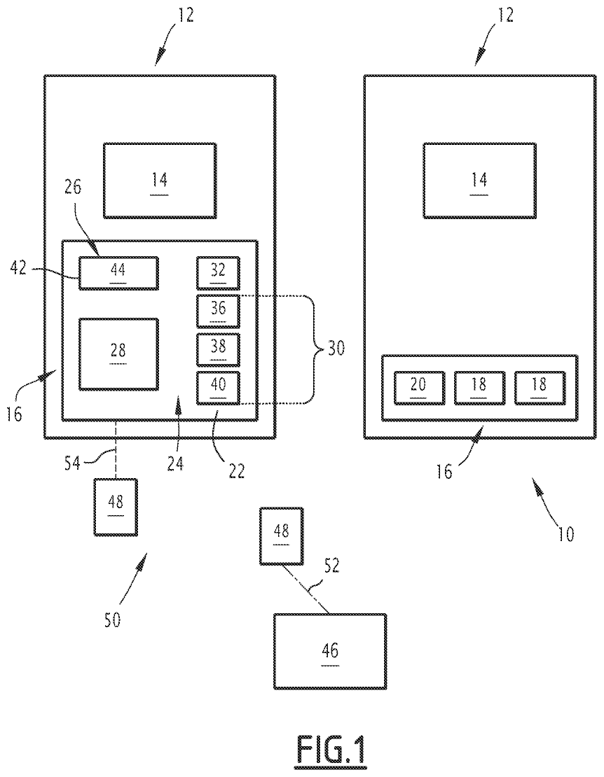

A group of industrial sites 10 is illustrated schematically in FIG. 1.

The group 10 includes a plurality of industrial sites 12.

In FIG. 1, only two industrial sites 12 are shown, but the number of industrial sites 12 can be as large as desired.

An industrial site 12 is a site grouping together a group of industrial systems in operation.

The industrial site 12 e.g. is a manufacturing plant or a production plant, in particular a power plant.

Each industrial site 12 includes a local system 14 for centralized control of access rights, referred to as the local control system 14, and at least one industrial system 16.

In each of the industrial sites 12 shown as an illustration, only one industrial system 16 is shown.

The local control system 14 checks in particular that the persons who access the site are authorized persons.

The industrial system 16 includes a set of equipment 18 and a control unit for access to equipment 20.

In the example proposed, the first industrial site 12 (the site on the left in FIG. 1) includes a single industrial system 16 which is a power supply 22.

The power supply 22 is suitable for supplying electrical power to other elements, and e.g. to other industrial systems.

In the proposed case, the power supply 22 includes a plurality of pieces of equipment 24 and a control unit for access to the pieces of equipment 26.

According to the example described, the pieces of equipment 24 of the power supply 22 are a battery 28, auxiliary equipment piece 30 and the battery management system 32.

A battery 28 is a generic term for a set of electric accumulators, called cells, connected therebetween so as to form an electric generator of desired voltage, power and capacity. A battery 28 converts the electrical energy accumulated during the charging phase into chemical energy. The chemical energy consists of electrochemically active compounds arranged in the cell. Electrical energy is restored by converting chemical energy into electrical energy during the discharge phase. The electrodes are arranged in a container and are electrically connected to current output terminals which provide electrical continuity between the electrodes and an electrical consumer with which the cell is associated. The battery 28 is formed of one or a plurality of branches electrically connected in parallel. Each branch comprises one or a plurality of modules electrically connected in series, and each module comprising one or a plurality of electrochemical cells electrically connected in series or in parallel.

As a particular example, a battery 28 is a set of a plurality of electrochemical cells which are connected in series and arranged together in the same chamber so as to form a first module. Similarly, each module includes a plurality of electrochemical cells connected in series and arranged in a respective chamber. The modules are connected in series so as to form a battery 28. The modules form a branch of the circuit. Such a circuit branch is often referred to as ESSU in reference to the English name “Energy Storage System Unit”.

In a variant, the cells are connected in parallel.

It is also conceivable to connect certain cells therebetween in parallel so to obtain a plurality of associations of cells in parallel and then connect the associations of cells in series.

Similarly, the battery 28 can comprise any number of modules, in a configuration not necessarily limited to a connection in series. The battery can e.g. comprise parallel branches, each parallel branch comprising at least one module consisting of at least one cell.

Each piece of auxiliary equipment 30 has a specific function, each specific function being most often related to the safety, security, performance or to the operation of the battery.

In the example described, the power supply 22 includes three pieces of auxiliary equipment 30 which are now described.

The first piece auxiliary equipment 36 is a fire detection and extinguishing system.

Such a system is configured for preventing the spread of fire if one or a plurality of electrochemical modules catch fire.

A second piece of equipment 38 is an air conditioning system.

Such a system is configured for maintaining the battery under temperature conditions which ensure the optimal operation thereof.

A third piece of equipment 40 is a system for measuring electrical power.

The electrical power measured by the third piece of equipment is e.g. the electrical power delivered and/or received by the battery.

Other auxiliary equipment 30 are conceivable such as a system for monitoring physical access to the battery (e.g. the room wherein the battery is stored).

The battery management system 32 is suitable for controlling the battery 28 and at least one piece of auxiliary equipment 30.

The control unit for access to equipment 26, called hereinafter the control unit 26, is suitable for controlling the access to the equipment 24, by means of an operator.

According to the example described, the control unit 26 includes an interface 42 and a computer 44.

The interface 42 enables an operator wishing to access a piece of equipment 24, to enter data for requesting the access.

The operator herein is qualified person capable of carrying out any type of operations on at least one piece of equipment 24, and in particular maintenance operations.

A set of operations to be conducted is sometimes referred to as a mission. The term action will be used hereinafter in the present description.

The interface 42 is e.g. a touch-sensitive interface or a screen and keyboard assembly.

The computer 44 is used to check the data entered and to either authorize or not authorize access depending on the data.

The set of industrial sites 10 is also provided with a centralized control system for access rights 46, called hereinafter the centralized control system 46.

The centralized control system 46 is suitable for generating digital certificates authorizing an operator to access at least one piece of equipment 24 of the power supply 22 in order to carry out a predefined action.

A digital certificate is, by definition, a set of information data relating to the operation to be carried out along with a signature of the centralized control system 46.

The presence of the signature is a guarantee that all the information data contained in the digital certificate is true.

In this sense, the centralized control system 46 is a certificate authority.

A certificate authority (CA) is a trusted third party which authenticates information data.

The signature is generated with a secure cryptographic hashing algorithm with the associated cryptographic parameters (e.g. number of cycles) necessary for obtaining a sufficient level of security, such as e.g. SHA-2.

Furthermore, the digital certificate uses a secure asymmetric cryptographic system for encrypting the signature, with the associated cryptographic parameters (e.g. key size) necessary for achieving a sufficient level of security depending on the action required and on the lifetime of the cryptographic material used, such as e.g. the RSA (Rivest-Shamir-Adleman) algorithm with 4096-bit keys.

In the present case, the digital certificate includes a public key, the identity of the operator, the action, the date of beginning of validity of the digital certificate, the date of end of validity of the digital certificate and a unique serial number.

Thereby, the digital certificate is a unique and temporary certificate.

The above increases safety and enhances good traceability.

It should be noted that the action can also be expressed in the form of a role.

Typically, a specialist in the electrical power measurement system 40 does not have to access an air conditioning system 38.

In the example described, the digital certificate is in the form of an X.509 format file.

For such a generation, the centralized control system 46 gets the information data thereof from a web application.

A web application is an application which can be handled directly on-line through a web browser or an intranet and thus does not require installation on client machines.

To access the web application, the operator is equipped with a specific terminal 48 thereof.

The terminal 48 is, according to the example shown FIG. 1, a smartphone.

More generally, the terminal 48 can be seen as a computer system which can interact with one or a plurality of computer programs.

A computer system is an electronic computer suitable for handling and/or transforming data represented as electronic or physical quantities in computer registers and/or memories into other similar data corresponding to physical data in memories, registers or other types of display, transmission or storage.

The computer system includes a processor comprising a data processing unit, memories and a data medium drive. The computer further comprises a human-machine interface, e.g. a keyboard and a display unit.

The computer program product includes a readable storage medium.

A readable storage medium is a medium readable by the computer system, usually by the drive. The readable storage medium is a medium suitable for storing electronic instructions and apt to be coupled to a bus of a computer system.

As an example, the readable storage medium is a diskette or a floppy disk, an optical disk, a CD-ROM, a magneto-optical disk, a ROM, a RAM, an EPROM, an EEPROM, a magnetic card or an optical card.

A computer program containing program instructions is stored on the readable storage medium.

The computer program can be loaded to the data processing unit and is suitable for generating the implementation of a desired method.

Such description of a computer system is valid for all elements involving computer elements.

As a particular example, the control unit 26 can be seen as a computer system.

Finally, it should be noted that the terminal 48 together with the control unit 26 form a system 50 for securing the operation of the power supply 22.

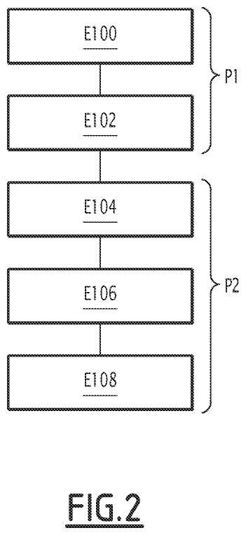

The operation of the system 50 for securing will now be described with reference to FIG. 2, which is a flowchart of an example of implementation of the method for securing the power supply 22.

The method for securing is a process aimed at securing the operation of the power supply 22 by preventing the carrying out of an action which is either unauthorized or carried out by unqualified personnel.

The method for securing includes two phases: a phase of obtaining a digital certificate P1 and a phase P2 of attempting to access at least one piece of equipment 24 of the power supply 22.

The obtaining phase P1 is a phase of obtaining a digital certificate authorizing access to at least one piece of equipment 24 of the power supply 22.

The obtaining phase P1 includes two steps which are a generation request step E100 and a reception step E102.

During the generation request step E100, the generation of the digital certificate is requested by the centralized control system 46, the digital certificate being a unique and temporary digital certificate.

According to the example proposed, the generation request step E100 includes three operations: connection, preparation and sending.

During the connection operation, the operator connects to the application.

To this end, the operator enters an identifier and a password on the terminal thereof.

Such a connection relies on the fact that the operator has been declared beforehand as an authorized operator to the centralized control system 46.

To improve security, the operator identification can be double checked by the use of a single-use token in addition to the identifier/password pair.

During the preparation operation, the operator enters information data on the web application so as to prepare a request to generate the digital certificate.

To this end, the operator enters a date of beginning of validity of the digital certificate.

The date of beginning often corresponds to the expected date of the action thereof on the power supply 22.

According to the example described, the operator specifies the nature of the action thereof.

During the sending operation, the prepared request is sent to the centralized control system 46.

The sending is e.g. performed by the web application following a selection by the user, on the terminal 48, of a Send button.

The centralized control system 46 then generates a digital certificate on the basis of the prepared request.

In particular, as indicated above, the digital certificate includes a date of end of validity.

According to the example described, the date of end of validity is calculated from the date of beginning by adding a predetermined time interval.

As an illustration, the time interval is chosen to be 7 days.

However, in a more elaborate embodiment, the time interval depends on the piece of equipment 24 on which the action is planned.

The digital certificate also includes a predefined action.

During the reception step E102, the generated digital certificate is received.

As a particular example e.g., the operator downloads to the terminal 48 thereof, the file comprising the digital certificate generated by the centralized control system 46.

At the end of the obtaining phase P1, the operator thus has a digital certificate certified by the centralized control system 46.

The phase of obtaining P1 was carried out by connecting to the web application. Such an obtaining phase P1 is thus a phase implemented on-line through a link between the terminal 48 and the centralized control system 46 via the web application. The link is represented by dotted lines 52 in FIG. 1.

On the other hand, the access attempt phase P2 does not involve the presence of an Internet link, hence, for the example described, same is considered as an off-line phase.

The access attempt phase P2 is a phase during which an attempt is made to access at least one piece of equipment 24 of the power supply 22 using the digital certificate obtained at the end of the obtaining phase P1.

According to the example described, the access attempt phase P2 includes an access request step E104, a checking step E106 and an access authorization step E108.

During the access request step E104, the operator requests access to the equipment 24 via the control unit 26.

The access request comprises entering a plurality of data, at least one of the plurality of data concerning the digital certificate.

In the case illustrated, the operator enters an action on the control unit 26 and sends the file to the control unit 26.

Moreover, the operator sends the certificate thereof to the control unit 26 using the terminal 48 (see dotted lines 54 in FIG. 1) thereof.

The checking step E106 is a step of checking, by means of the control unit 26, the compliance of the access request with at least one compliance requirement, at least one compliance requirement being a compliance requirement relating to the digital certificate.

Otherwise stated, during the checking step E106, the control unit 26 checks whether or not a number of compliance requirements on the plurality of data are checked.

According to the example proposed, the control unit 26 checks five compliance requirements which are presented hereinafter.

In a first step, the control unit 26 checks a compliance requirement relating to the integrity of the digital certificate.

The purpose herein is to check whether the digital certificate has not been modified since the generation thereof, i.e. that the certificate is authentic.

If the compliance requirement is not validated, the other conditions are not checked.

When the integrity compliance requirement is checked, the control unit 26 then checks other additional compliance requirements (herein, four).

The order in which the additional compliance requirements are checked is irrelevant.

An additional compliance requirement relates to the identity between the action entered on the control unit 26 and the action defined by the digital certificate.

As explained above, if the nature of the action can be characterized by a role, the first compliance requirement is the identity of the entered role and of the role contained in the digital certificate.

Another additional compliance requirement relates to the signature of the digital certificate.

More precisely, the control unit 26 checks whether the signature is a signature of the centralized control system 46.

Yet another compliance requirement relates to the date of beginning of validity. The fourth compliance requirement is met when the date of beginning of validity is later than the current date.

The last additional compliance requirement is similar to the previous compliance requirement but relates to the date of end of validity. The compliance requirement is met when the date of end of validity is earlier than the current date.

The last two additional compliance requirements can be used for checking that the request for access to at least one piece of equipment 24 of the power supply 22 is within the time interval of validity of the digital certificate.

In the example proposed, at the end of the checking step E106, the control unit 26 has checked that the different compliance requirements are fulfilled.

The authorization step E108 is then implemented.

The control unit 26 then authorizes the operator to access at least one piece of equipment 24 of the power supply 22.

On the other hand, if one or a plurality of compliance requirements are not fulfilled, the control unit 26 denies access to at least one piece of equipment 24 of the power supply 22.

The method described thus allows the operator to be authenticated and thus to identify and authenticate by name, the operators who would intervene on an industrial site 12, rather than using anonymous generic accounts.

Moreover, the method is hybrid since same comprises two phases P1 and P2, one of which is on-line and the other is off-line. The method thus makes it possible to extend the authentication of the operator without being in control of the initial certification authority (herein, the centralized control system 46) and without having access to such authority in the off-line environment.

Otherwise formulated, using the on-line authentication methods of the centralized control system, a certificate is generated which can be designed as a cryptographic object which allows the operator to be authenticated in another environment, off-line this time, with a completely separate certificate chain.

The centralized nature of the certificate generation ensures better security because all the means of identification of an action are listed in a single place. More particularly, the identifiers and rights are updated centrally on the centralized control system 46 (and no longer on the industrial site 12).

The above prevents e.g. an operator in possession of a generic password from intervening on a site for which the operator does not have an authorization.

Moreover, the uniqueness of the digital certificate provides a good traceability of the actions carried out with the logging of information such as e.g. the name of the operator, the date of creation of the certificate, the date of attempted use of the certificate, the serial number of the certificate, the type of action.

Access to the equipment 24 is thus perfectly controlled, which prevents the power supply 22 and more generally the industrial system 16 from being incorrectly configured.

In the end, the method for securing can be used effectively in all cases which could arise in practice when an operation is to be carried out on the industrial system 16.

Other embodiments are conceivable.

Additional or different compliance requirements could be considered.

The identity of the operator e.g. could be checked.

Similarly, in particular when the operator is from another company, the manufacturer of the Industrial system 16 or the original company thereof could be checked.

The authorization could be of a plurality of degrees.

Some parameters e.g. of a piece of equipment could be accessible for maintenance and others could be not accessible.

In addition, the digital certificate can be used for the traceability of one or a plurality of files generated as part of the mission.

The operator e.g. may have to generate a configuration file containing the new setting parameters imposed on the piece of equipment. The file could also be an in situ test file of a new part installed on the piece of equipment.

The fact that such files include the digital certificate makes it easy to determine who the author of the files is and when the author generated the files. Traceability during maintenance is improved in this way.

1. A method for securing the operation of an industrial system, the industrial system comprising a set of pieces of equipment and a control unit accessing the equipment, the industrial system being part of an industrial site, the industrial site being part of a group of industrial sites, the group of industrial sites comprising a single centralized control system for access rights,
the method comprising:
a phase of obtaining a digital certificate authorizing an operator to access at least one piece of equipment of the industrial system to carry out a predefined action, the obtaining phase comprising a step of:
requesting a generation of a digital certificate by the centralized control system for access rights, the digital certificate being a unique and temporary digital certificate, and
reception of the digital certificate,
a phase of attempting to access at least one piece of equipment of the industrial system to carry out an action on said at least one piece of equipment, the attempt phase comprising a step of:
requesting access to at least one piece of equipment of the industrial system by entering a plurality of data relating to the action to be carried out on the control unit to access the equipment, at least one of the plurality of data concerning the digital certificate,
checking, with the control unit for access to equipment, the compliance of the access request with at least one compliance requirement, at least one compliance requirement being a compliance requirement relating to the digital certificate, and
authorizing access to at least one piece of equipment of the industrial system to carry out the action when each compliance requirement is met or
refusing access to the at least one piece of equipment of the industrial system when a compliance requirement is not met.

2. The method for securing according to claim 1, wherein the industrial system is a power generation system or an energy storage system.

3. The method for securing according to claim 1, wherein the industrial system is a power supply including a battery and a battery management system and at least one piece of auxiliary equipment.

4. The method for securing according to claim 3, wherein each piece of auxiliary equipment is selected from the group consisting of a fire detection and extinguishing system, an air conditioning system and an electrical power measurement system.

5. The method for securing according to claim 1, wherein the method further includes:
connecting to a web application,
preparing a request to generate the digital certificate by entering information on the web application, so as to obtain a prepared request, and
sending the prepared request to the centralized control system for access rights for the generation of a digital certificate on the basis of the information entered on the web application.

6. The method for securing according to claim 1, wherein each compliance requirement relating to the digital certificate is selected from the following list of compliance requirements:
an interval of validity being defined for the digital certificate, the request for access to at least one piece of equipment of the industrial system is within the time interval of validity of the digital certificate,
the data relating to the action to be carried out entered into the control unit for access to equipment is the same as the action indicated in the digital certificate, and
the digital certificate is authentic.

7. An industrial system comprising a set of pieces of equipment and a control unit for access to equipment, the industrial system being part of an industrial site, the industrial site being part of a group of industrial sites, the group of industrial sites comprising a single centralized control system for access rights, the control unit accessing equipment configured for:
receiving a plurality of data on the control unit for access to equipment, at least one of the plurality of data relating to a digital certificate authorizing access to at least one piece of equipment of the industrial system, the digital certificate having been generated by the centralized control system for access rights, the digital certificate being a unique and temporary digital certificate, all data forming a request for access to at least one piece of equipment of the industrial system,
checking the compliance of the access request with at least one compliance requirement, at least one compliance requirement being a compliance requirement relating to the digital certificate, and
authorizing access to at least one piece of equipment of the industrial system when each compliance requirement is met or refusing access to at least one piece of equipment of the industrial system when a compliance requirement is not met.

8. A system for securing the operation of an industrial system comprising a set of pieces of equipment and a control unit accessing the equipment, the industrial system being part of an industrial site, the industrial site being part of a group of industrial sites, the group of industrial sites comprising a single centralized control system for access rights, the system for securing including a terminal used for obtaining a digital certificate authorizing access to at least one piece of equipment of the industrial system, the terminal being configured for:
requesting the generation of a digital certificate by the centralized control system for access rights, the digital certificate being a unique and temporary digital certificate, and
receiving the digital certificate,
the control unit for access to equipment being configured for:
receiving a plurality of data on the control unit for access to equipment, at least one of the plurality of data relating to the digital certificate, all data forming a request for access to at least one piece of equipment of the industrial system,
checking the compliance of the access request with at least one compliance requirement, at least one compliance requirement being a compliance requirement relating to the digital certificate, and
authorizing access to at least one piece of equipment of the industrial system when each compliance requirement is met or refusing access to at least one piece of equipment of the industrial system when a compliance requirement is not met.

9. A computer program product including program instructions stored on a readable information medium implementing steps of the method according to claim 1 when the computer program is run on a data processing unit.

10. A readable information medium having program instructions stored thereon, implementing steps of the method according claim 1 when the computer program is run on a data processing unit.
